(19) United States
(12) Patent Application Publication
(10) Pub. No.: US 2009/0278653 A1
(43) Pub. Date: Nov. 12, 2009

(54) Device for Operating an Electrical Device of an Automation System

(75) Inventor: Thomas Jachmann, Wendelstein (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 11/915,405

(22) PCT Filed: May 26, 2005
(86) PCT No.: PCT/DE05/00972

§ 371 Date: Nov. 26, 2007

(51) Int. Cl. G05B 19/042; G05B 19/00

(52) U.S. Cl. 340/5.2; 700/23; 700/17

(57) ABSTRACT

An electrical device of an automation system is operated by carrying out the following steps: an electronic control device of the electrical device detects an external data storage module which is connected to the device; the electronic control device reads a control program stored on the external data storage module, the control program including a control command sequence for calling functions of the electrical device, and the electronic control device executes the command sequence contained in the control program.

Automation systems for controlling automated processes, for example an electrical power supply system, a chemical or process-engineering process or an industrial manufacturing process, usually have a multiplicity of electrical devices. Such electrical devices may be, for example, electrical field devices or control center devices. Electrical field devices are usually arranged in the vicinity of the process and record the respective operating state of measured values, which characterize the automated process, and/or issue commands to so-called actuators which act directly on the process. For example, a command for opening or closing a switch in an electrical power supply system may be issued. Control center devices are devices which are arranged above the electrical field devices in the automation hierarchy and are usually arranged in so-called control centers or control rooms. These control center devices make it possible for an operator to observe and evaluate the status of the entire automation system or a part of the latter, on the one hand, and to issue control commands to the respective field devices in the automation system, on the other hand.

In order to match the individual electrical devices of an automation system to the automated process, on the one hand, and to one another, on the other hand, and thus to ensure reliable functional operation of the automation system, it is often necessary to carry out particular setting operations in the respective electrical devices. For example, communication protocols must be selected and configured so that the individual electrical devices in a communication network can interchange data with one another. It may also be the case that extended software, a so-called firmware update, must be installed in order to incorporate new functionalities of the electrical devices of the automation system, different operations on the respective electrical device of the automation system being required in order to install said software.

In order to carry out said setting operations and other setting operations in the electrical devices, an operator must previously look for the respective electrical device and carry out the corresponding function inputs manually using an input apparatus, for example a keypad of the respective electrical device. Since electrical field devices of automation systems nowadays have a multiplicity of different functions, the latter are usually structured in so-called menus and submenus. In order to input and select the respective functions required, the operator must navigate through this predefined menu structure. This procedure is often comparatively time-consuming.

The invention is based on the object of reducing the effort when operating an electrical device of an automation system.

In order to achieve this object, the invention specifies a method for operating an electrical device of an automation system, in which an electronic control device of the electrical device detects an external data storage module which is connected to the device, reads a control program stored on the external data storage module, the control program comprising a control command sequence for calling functions of the electrical device, and the electronic control device executes the control command sequence contained in the control program.

The particular advantage of the method according to the invention is that all control commands to be input are stored on the external data storage module in the form of a control command sequence for calling functions of the electrical device, with the result that the operator no longer has to individually manually select the corresponding functions from the menu structure of the electrical device. Rather, the individual functions are automatically carried out in the order predefined by the control program.

The external data storage module may be, for example, a so-called USB stick, flash memories in the form of memory cards, floppy disks or CD ROMs or DVD ROMs. The external data storage module may be connected to the electrical field device in both wired and wireless form, for example using Bluetooth, radio or infrared.

One advantageous embodiment of the method according to the invention is provided by virtue of the fact that the electronic control device includes linking data for the control program in a control menu of the electronic device, and the electronic control device executes the control command sequence contained in the control program only when the control program has been selected in the control menu. This makes it possible to provide a plurality of control programs on the external data storage module and to display them for the operator of the electrical field device in a control menu for the purpose of selection. The operator always has full control over which control program is intended to carry out functions in the respective electrical device.

Another advantageous embodiment of the method according to the invention provides for the control program to comprise device association data, for the electronic control device to compare the device association data with a device identifier of the electrical device, and for the electronic control device to execute the sequence of control commands only when it detects that the device association data match the electrical device. This makes it possible to store a plurality of control programs for different electrical devices on the external data storage module. The respective electrical device can use the device association data of each individual control program to easily detect whether execution of the control program on the corresponding electrical device is intended.

In order to make it possible for the operator to influence the functions carried out in the respective electrical device in accordance with the control command sequence to the greatest possible extent, another advantageous embodiment of the method according to the invention may provide for the electronic control device to generate an acknowledgement request before executing particular control commands of the control program, and for the electronic control device to execute the corresponding control command only after the acknowledgement request has been acknowledged. For example, in the case of particular safety-relevant functions, it is thus possible to check, before said functions are carried out, whether the operator actually agrees to this function being carried out.

In addition, another advantageous embodiment of the method according to the invention may also provide for the electronic control device to generate an input request before executing particular control commands of the control program, and for the electronic control device to execute the corresponding control command only after input data, for example in the form of a numerical value, have been input. This embodiment is particularly advantageous when, although the same command sequence is intended to be carried out, in principle, in a plurality of devices, particular setting and parameterization values, for example, are intended to be set differently from device to device. In this case, whenever it is possible to input a setting or parameterization value, the electrical control device outputs an input request to the operator who then has the opportunity to input the desired setting or parameterization value in the form of an input value.

Another advantageous embodiment of the method according to the invention also provides for the electronic control device to generate a password input request before executing those control commands which are used to call password-protected functions of the electrical device, and for the electronic control device to execute the corresponding control command only after password data which specify a suitable password have been input. This makes it possible to prevent password-protected functions of the electrical device, for example the opening or closing of a high-voltage circuit breaker, from being automatically carried out in an undesirable manner by virtue of the operator being requested to input a corresponding password before executing a control command which calls such a function.

It is also possible to provide, for example, for a control program generated using a separate data processing device to be used as the control program. In this case, a so-called engineering tool, that is to say software which images the automation system and can be used to develop corresponding settings for the respective devices of the automation system, can be used to generate the control program. Such engineering tools are often present in engineer workstations which are remote from the actual automation system. The corresponding control program can then be developed using the engineering tool and stored on the external data storage module. The control program can be executed later in situ in the corresponding electrical device. A particular advantage of this method is also, in particular, that there does not need to be any correspondence between the person who creates the control program and the person who connects the control program on the external data storage module to the electrical device of the automation system.

Alternatively, however, it is also possible to provide for a control program which has been generated while calling individual functions of the electrical device by virtue of the electronic control device storing the individual called functions in the form of a command sequence in accordance with their temporal sequence to be used as the control program. In this case, a recorder function of the respective electrical device may be used as it were to create a control program in a particularly simple manner, in such a way that an operator carries out a sequence of function calls in the electrical device once. The electronic control device of the electrical device “remembers” the sequence of functions which have been carried out and stores it in the form of a command sequence on the external data storage module. The command sequence which has been stored in this manner can then be carried out in other electrical devices without the need for a manual function input.

In order to also specify the simplest possible method for generating a control program for an electrical device of an automation system, the invention also provides a method for generating a control program for operating an electrical device of an automation system, in which the following steps are carried out:

an electronic control device (6) of the electrical device (1) records functions which are called in the electrical device (1) in accordance with the temporal order in which they are called, and
the electronic control device (6) stores control commands belonging to the called functions in the form of a control command sequence while generating the control program.

This makes it possible as it were to use a recorder function of the electrical device to generate a control program without this requiring special programming knowledge.

In order to explain the method according to the invention in more detail,

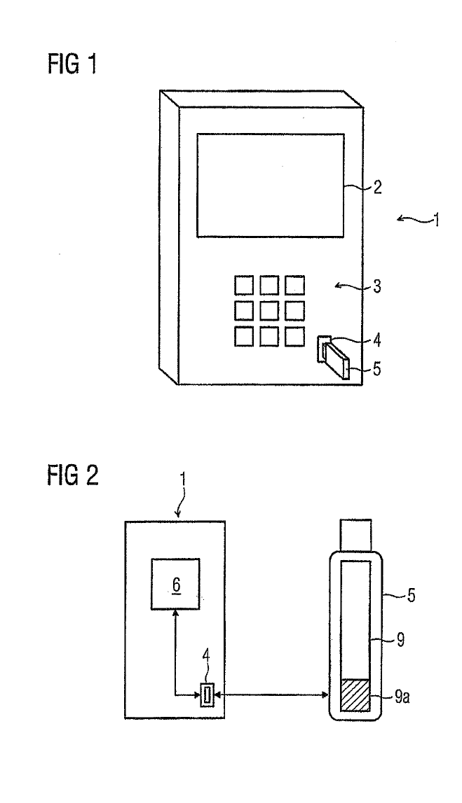

FIG. 1 diagrammatically shows an electrical field device having an external data storage module,

FIG. 2 shows a diagrammatic block diagram for explaining a method for adapting an electrical field device,

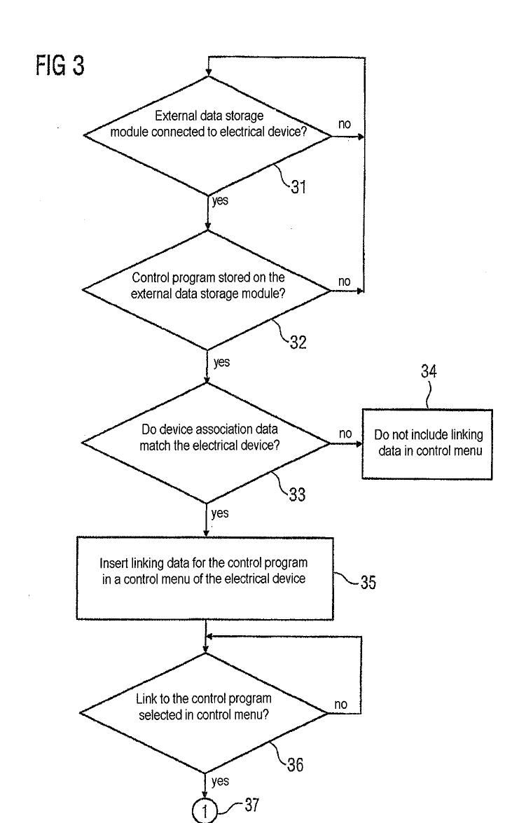

FIG. 3 shows a method flowchart for explaining the method for setting a field device,

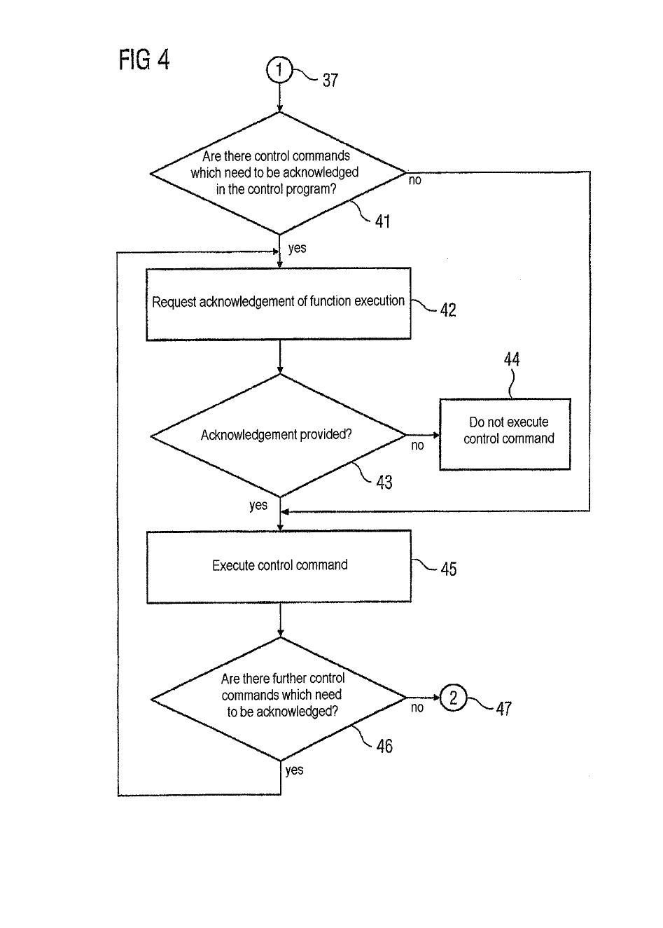

FIG. 4 shows another method flowchart for continuing the method explained in FIG. 3, and

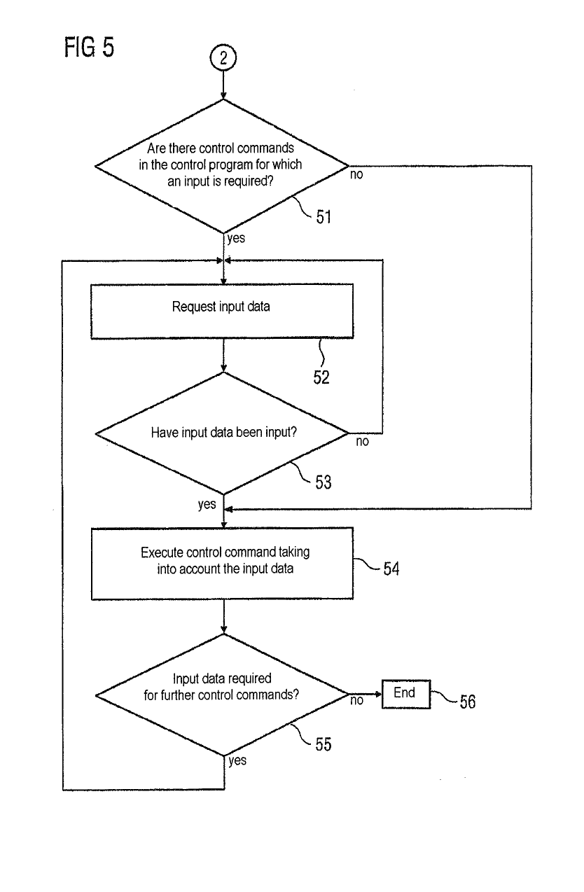

FIG. 5 shows another method flowchart for continuing the method explained in FIG. 4.

FIG. 1 shows an electrical device 1 in the form of a field device. Such field devices are usually used in automation systems for automatically controlling power supply systems, for example. In addition, field devices of this type may be used in chemical or process-engineering systems, industrial manufacturing processes or systems for supplying gas and water. The field devices are usually placed in the vicinity of the respective process to be automated and have measurement inputs for recording measured values from the automated process and control outputs for issuing control commands to actuators of the automated process, for example for opening or closing a switch. In addition, field devices may have communication inputs and outputs which they use to interchange data with other field devices, on the one hand, and control centers of the automation system, which are arranged above them in the control hierarchy, on the other hand.

Use of the method according to the invention is not restricted to electrical field devices. Rather, it can be used in virtually all electrical devices of an automation system, in particular in control center devices as well.

The electrical device 1 has a display apparatus 2, for example a display, and an input apparatus 3 in the form of a keypad. An electronic control device which controls the functions of the electrical device 1 is not illustrated in FIG. 1. The electronic control device will be addressed in connection with FIG. 2.

In addition, the electrical device 1 has a data interface 4 into which an external data storage module 5, which is illustrated in this case in the form of a USB stick by way of example, has been inserted. However, the external data storage module 5 need not necessarily be a USB stick; rather, all possibilities for external data storage modules, for example floppy disks, CD ROMs, DVD ROMs, flash memory cards or else external hard disks, are possible. The data interface 4 of the device 1 respectively has to be configured differently in accordance with the possibilities for connecting the external data storage module 5. Instead of a contact-based electrical connection between the data interface 4 and the external data storage module 5, as indicated in FIG. 1 by the inserted USB stick, wireless transmission methods are furthermore also conceivable between the external data storage module 5 and a data interface 4 of the device 1 which is appropriately configured for wireless data transmission, for example by means of Bluetooth, infrared or radio.

An operator of the electrical device can use the input apparatus 3 to carry out setting operations in the electrical device 1. To this end, a function menu from which the operator can select appropriate functions using the input apparatus 3 is usually displayed on the display apparatus 2. Such function menus are sufficiently well known from the technology of computer applications. A plurality of function menus are often present in a complex menu structure which is distinguished by a plurality of coordinate and subordinate individual function menus. In order to find a specific function, the operator must often navigate through a plurality of menu levels in order to be able to finally call the desired function. In addition, parameters and/or setting values must often be input to the electrical device 1 in order to carry out particular functions.

Operation of an electrical device is considerably simplified by the method described in connection with FIG. 2. In this respect, FIG. 2 shows the device 1 in an extremely diagrammatic illustration. The device 1 has an electronic control device 6 which controls the functions of the device 1. The control device 6 is connected to the data interface 4 of the device 1. The electronic control device 6 is able to access the external data storage module 5 by means of the data interface 4 of the device 1. The external data storage module 5 has a memory device 9 to which data can be written and from which data can be read. An area 9a of the memory device 9, which is illustrated in hatched fashion in FIG. 2, contains at least one control program comprising a sequence of control commands for carrying out functions of the device 1.

If the external data storage module 5 is connected to the device 1, the electronic control device 6 of the device 1 detects the presence of the external data storage module 5. This is also shown in a first step 31 in FIG. 3.

The method for operating the electrical device 1 shall be explained in more detail below using the method flowcharts illustrated in FIGS. 3, 4 and 5.

As soon as the presence of an external data storage module 5 has been detected by the electronic control device 6 in step 31, said control device checks, in the further step 32, whether a control program is stored on the external data storage module 5. If a control program is not found on the external data storage module 5, the method begins to run from the beginning until a data storage module 5 containing a control program has been detected by the electronic control device 6 of the electrical device 1.

If a control program is stored on the external data storage module 5, the electronic control device 6 checks, in a following step 33, whether device association data contained in the control program match a device identifier of the electrical device 1. If matching device association data are not discovered in the control program, the method sequence is aborted here. If necessary, the operator of the electrical device 1 can use a display of the electrical device 1, for example, at this juncture to display a message stating that a control program has not been found for the respective electrical device 1.

The practice of adding device association data to the respective control program makes it possible to ensure in a very simple manner that a control program is executed only in the electrical devices provided for this purpose. For example, in this manner, a first person, for example an engineer responsible for the automation system, can generate a control program for a specific electrical device and can store it on the external data storage module 5. For example, this control program may change particular configurations of the specific electrical device.

However, so that the control program is not executed inadvertently in an incorrect electrical device and the configurations of the latter are not changed in an undesirable manner, device association data which clearly specify that the control program may be executed only in a particular electrical device are added to the control program. Alternatively, a plurality of device association data items which make it possible to execute the control program in a group of electrical devices may of course also be assigned to the control program.

A second person, for example a technician who deals directly with the electrical devices of the automation system, can then connect the data storage module 5, including the stored control program, to the corresponding electrical device and can execute the control program. There is now no risk of the control program being executed in an incorrect electrical device because the control device of the respective electrical device first of all checks the device association data of the control program and prevents the control program from being executed if the device association data do not match the electrical device.

If it is detected that the device association data of the control program match the electrical device 1, a link to the control program is included in a control menu of the electrical device 1 in a subsequent step 35.

The operator can now find the link to the control program in the control menu of the electrical device 1 and can select it if necessary. If a plurality of control programs which match the electrical device 1 are present on the external data storage module 5, a plurality of links to the respective control programs are also correspondingly displayed in the control menu. The operator can then easily select, from the control menu, precisely that control program which is intended to be executed next. If, in accordance with step 36, the link to a particular control program has been selected in the control menu, the following entry mark 37 refers to the continuation of the method in accordance with FIG. 4.

In accordance with FIG. 4, a step 41 checks, while executing the individual control commands belonging to the control program, whether the execution of a respective control command requires acknowledgement by the operator of the electrical device 1. Such control commands which need to be acknowledged may be aimed, for example, at safety-relevant functions of the electrical device 1, for example the opening or closing of a circuit breaker of an electrical power supply system.

If there are no control commands which need to be acknowledged in the control program, the function of the control program can be carried out directly in accordance with field 45.

If, however, there are one or more control commands which need to be acknowledged in the control program, an acknowledgement request is generated by the electronic control device 6. For example, this acknowledgement request may be displayed in the form of a text window using the output device 2 of the electrical device 1. This acknowledgement request is also used to indicate the control command to be executed to the operator of the electrical device 1, and the operator is requested to provide his acknowledgement for executing this control command. The acknowledgement can be provided, for example, by pressing a particular acknowledgement key on the electrical device 1 for a correspondingly long time or by inputting a special acknowledgement code. If the function of the electrical device 1 which is to be called by the corresponding control command is a password-protected function, a request to input corresponding password data is also output together with the acknowledgement request according to field 42. The operator can input such password data, for example in the form of an alphanumeric character string, on the keypad of the electrical device 1. Alternatively, however, the password data may also be already stored on the external data storage module 5, from which the electronic control device can retrieve them without the need for a manual input. If the operator has provided the acknowledgement and has input the password, if necessary, the corresponding control command is executed in accordance with field 43.

Otherwise, field 44 provides for the corresponding control command not to be executed. The electronic control device of the electrical device 1 can discern the fact that the operator does not provide the acknowledgement, for example, from the fact that an abort key has been pressed or a predefined period of time has elapsed without the operator having provided an acknowledgement or having input a password.

After the corresponding control command has been executed in accordance with field 45, field 46 once again checks whether there are further control commands which need to be acknowledged or further password-protected control commands. If this is the case, the method sequence is correspondingly repeated from field 42. If this is not the case, an entry mark 47 refers to the further functional sequence in FIG. 5.

In accordance with FIG. 5, the individual control commands of the control program are checked in order to determine whether it is necessary to input a parameter value, for example, for them. If this is not the case, the corresponding control command can be executed directly in accordance with field 54. If, however, an input is required for a particular control command in accordance with field 51, the electronic control device 6 generates an input request, for example in the form of a text window which explains to the operator that an input is required in order to execute the particular control command. As soon as the input data have been input, the corresponding control command is executed taking into account the input data which have been input. Field 54 shows this.

Field 55 finally checks whether input data are also required for further control commands. If this is the case, the method explained is repeated from field 52. If this is not the case, the method is ended in accordance with field 56.

An electrical device 1 of an automation system can be operated with a considerable time saving using the method sequence shown. This is because the operator of the electrical device 1 need not select and activate the individual functions from the individual menus and submenus of the respective electrical device 1, but rather the control commands are automatically executed by the electronic control device 6 of the electrical device, thus activating the corresponding functions in the electrical device 1. For example, communication parameters of the electrical device 1 can thus be set in a rapid manner.

It should finally be mentioned that the method sequence illustrated in FIGS. 3, 4 and 5 can also be carried out with the omission of individual method steps. In particular, the operation of checking for particular device association data (field 33), the operation of checking for control commands which need to be acknowledged or for password-protected control commands (fields 41 to 46) or the operation of checking for control commands for which an input by the operator is required (fields 51 to 55), including the corresponding subsequent function steps, may thus be omitted and the method can be carried out in a correspondingly shortened form. The practice of including the control program in a control menu and the requisite operation of selecting the control program in the control menu (fields 35 and 36) could also be dispensed with. In such a case, the at least one control program stored on the external data storage module 5 would be executed immediately after the electronic control device 6 has detected the external data storage module 5 without further manual actions.

Two methods are available, in principle, for generating the control program. On the one hand, the control program can be generated using a separate data processing device. For example, a system engineer can use a so-called engineering tool, that is to say software for setting up and configuring the individual electrical devices of the automation system, to create the control program at his engineering workstation and can then store it on the external data storage module 5. The advantage of this possibility is that the system engineer himself does not have to execute the control program in the system. This can be carried out by a further person, for example a system technician who is on site at the system and carries the external data storage module with him. The execution of the control program can be stored on the external data storage module in the form of a protocol. In this manner, the system engineer nevertheless has an overview of the correct execution of the control program in the electrical device.

Another possible way of creating the control program is for the electronic control device to concomitantly write the control command sequence as it were while manually executing a particular control command sequence in the device. In this case, the electronic control device stores the individual control commands which have been executed in the order in which they have been called. The control command sequence stored in this manner then constitutes a control program which can be transmitted to the external data storage module and can be executed in the same device or in other devices at a subsequent point in time without the control command sequence having to be manually input again.

1-9. (canceled)

10. A method of operating an electrical device of an automation system, the method which comprises the following steps:
detecting, with an electronic control device of the electrical device, an external data storage module connected to the device;
reading, with the electronic control device, a control program stored on the external data storage module, wherein the control program includes a control command sequence for calling functions of the electrical device; and
executing the command sequence contained in the control program with the electronic control device.

11. The method according to claim 10, wherein:
the electronic control device includes linking data for the control program in a control menu of the electrical device; and
the electronic control device executes the control command sequence contained in the control program only when the control program has been selected in the control menu.

12. The method according to claim 10, wherein:
the control program comprises device association data;
the electronic control device compares the device association data with a device identifier of the electrical device; and
the electronic control device executes the control command sequence only when it detects that the device association data match the electrical device.

13. The method according to claim 10, which comprises:
generating an acknowledgement request with the electronic control device before executing particular control commands of the control program; and
executing the corresponding control command with the electronic control device only after the acknowledgement request has been acknowledged.

14. The method according to claim 10, which comprises:
generating an input request with the electronic control device before executing particular control commands of the control program; and
executing the corresponding control command with the electronic control device only after input data have been input.

15. The method according to claim 10, which comprises:
generating a password input request with the electronic control device before executing those control commands which are used to call password-protected functions of the electrical device; and
executing the corresponding control command with the electronic control device only after password data that specify a suitable password have been input.

16. The method according to claim 10, which comprises using a control program generated by a separate data processing device.

17. The method according to claim 10, which comprises using a control program that has been generated by the electronic control device by storing individually called functions of the electrical device as they are being called, and storing the individual called functions in the form of a control command sequence in accordance with their temporal sequence.

18. A method of generating a control program for operating an electrical device of an automation system, the method which comprises the following steps:
recording, with an electronic control device of the electrical device, functions that are called in the electrical device in accordance with a temporal order in which the functions are called; and
storing, with the electronic control device, control commands belonging to the called functions in the form of a control command sequence while generating the control program.
